(19) United States
(12) Patent Application Publication
(10) Pub. No.: US 2007/0225425 A1
(43) Pub. Date: Sep. 27, 2007

(54) Low tack elastomer composition, part and methods

(76) Inventors: Paul L. Nash, Corvallis, OR (US); Steven Lunceford, Corvallis, OR (US); Christopher John Vitello, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/388,256

(22) Filed: Mar. 24, 2006

(51) Int. Cl. C08G 18/42; C09B 67/00

(52) U.S. Cl. 524/500; 524/502

(57) ABSTRACT

An elastomer composition that includes a mixture of at least 50 parts per hundred rubber (phr) of a saturated elastomer and less than 50 parts per hundred rubber of an unsaturated elastomer. The mixture is halogenated after vulcanization producing an elastomer material having a tack at least 60 percent lower than a saturated tack of a composition having the saturated elastomer mixed with between about 40 phr and about 50 phr of the unsaturated elastomer, wherein the composition is vulcanized but not post vulcanization halogenated.

### BACKGROUND

### DESCRIPTION OF THE ART

Elastomer blends are useful in preparing a wide range of solid articles such as gaskets, hoses, tubing and the like. It has long been known that butyl vulcanizates generally exhibit a low residual unsaturation, which leads to chemical inertness, low permeability to gases, and less sensitivity to oxidative aging than are most unsaturated elastomers. However, saturated elastomers such as butyl rubbers (IIR), ethylene-propylene diene monomer terpolymers (EPDM), and ethylene-propylene rubbers (EPR), as well as most elastomers can suffer from high tack that is typically addressed via the use of powders such as talc, cornstarch, or other bioabsorbable powder as a release agent or tack reducer. For a given elastomer type, tack can also vary with filler and crosslink density variations. In many applications the use of powders to reduce tack would cause detrimental problems in use such as contamination. In addition, in those applications where contamination or other detrimental problem may result from the use of a powder and the application lends itself to or requires high volume manufacturing operations the use of a powder is further exacerbated because it is not easily removed in an automated assembly process. The ability to have elastomeric parts that do not stick together and have the ability to rapidly feed through automated assembly equipment is desirable to achieve aggressive thru-put and utilization goals in high volume manufacturing.

An area where contamination from powders is generally detrimental is in microfluidic devices. Fluid ejection cartridges and fluid supplies provide a good example of the problems facing the practitioner in preventing clogging or a reduction in fluid flow in microfluidic channels and chambers due to particle contamination.

Currently there is a wide variety of highly efficient inkjet printing systems in use, which are capable of dispensing ink in a rapid and accurate manner. However, there is a demand by consumers for ever-increasing improvements in speed and image quality. In addition, there is also increasing demand by consumers for longer lasting fluid ejection cartridges. In an effort to reduce the cost and size of ink jet printers and to reduce the cost per printed page, printers have been developed having small, moving printheads that are connected to large stationary ink supplies. This development is generally referred to as “off-axis” printing, and has allowed large ink supplies to be replaced as they are consumed without requiring the frequent replacement of the costly printheads containing the fluid ejectors and nozzle system. However, the typical “off-axis” system requires numerous flow restrictions between the ink supply and the printhead, such as additional orifices, long narrow conduits, and shut off valves. Typically, changes in the flow rate of the ink may greatly effect print density as well as print and image quality.

In addition, improvements in image quality have led to an increase in the complexity of ink formulations that increases the sensitivity of the ink to the ink supply and print cartridge materials that come in contact with the ink. Typically, these improvements in image quality have led to an increase in the organic content of inkjet inks that results in a more corrosive environment experienced by the materials utilized thus raising material compatibility issues.

In order to reduce both weight and cost many of the materials currently utilized are made from polymers such as plastics and elastomers. Many of these plastic and elastomer materials, typically, utilize various additives, such as stabilizers, plasticizers, tackifiers, polymerization catalysts, and curing agents. These low molecular weight additives are typically added to improve various processes involved in the manufacture of the polymer or elastomer and to reduce cost without severely impacting the material properties. Since these additives, typically, are low in molecular weight compared to the molecular weight of the polymer, they can be leached out of the polymer by the ink, react with ink components, or both, more easily than the polymer itself which can lead to degradation of the material properties. In either case, the reaction between these low molecular weight additives and ink components can also lead to the formation of precipitates or gelatinous materials, which can further result in degraded print or image quality.

If these problems persist, the continued growth and advancements in inkjet printing and other micro-fluidic devices, seen over the past decade, will be reduced. Consumer demand for cheaper, smaller, more reliable, higher performance devices constantly puts pressure on improving and developing cheaper, and more reliable manufacturing materials and processes. The ability to optimize fluid ejection systems, will open up a wide variety of applications that are currently either impractical or are not cost effective.

### BRIEF DESCRIPTION OF THE DRAWINGS

FIG. 1a is an exploded perspective view of a fluidic device according to an embodiment of the present invention.

FIG. 2a is a plan view of an elastomer gasket according to an embodiment of the present invention.

FIG. 2b is a cross-sectional view along 2b- 2b of the elastomer gasket shown in FIG. 2a.

FIG. 2c is a cross-sectional view along 2c- 2c of the elastomer gasket shown in FIG. 2a.

FIG. 3 is a flow diagram of a method of making an elastomer part according to an embodiment of the present invention.

FIGS. 4-6 are a graphs of the effect of post vulcanization chlorination on a different elastomer blends according to various embodiments of the present invention.

### DESCRIPTION OF THE PREFERRED EMBODIMENTS

This invention is directed to various elastomer compositions that utilize a post vulcanized halogenation of blended elastomers to promote low surface tack. It is generally known that elastomers are inherently tacky, which leads the formulator to consider variations in the additives to be utilized in a particular formulation such as the amount and nature of a particular detackifier, changes in processing conditions, and secondary operations may also be considered in order to achieve an acceptable tack value. The present invention advantageously utilizes a mixture of at least 50 parts per hundred of rubber of a saturated elastomer with less than 50 parts per hundred of rubber of an unsaturated elastomer. By varying the ratio of the saturated to unsaturated elastomer the optimization of various properties can be realized while obtaining elastomer parts having low surface tack. For example, by adding small quantities of an unsaturated elastomer to a saturated elastomer, with halogenation of the compound after vulcanization, parts having a low surface tack are obtained, without adversely impacting the overall physical and chemical properties of elastomeric material. By controlling the surface tack of a predominately saturated elastomer part without the use of a powder the utilization of high volume automated assembly equipment is realized.

In comparison, post chlorination of unsaturated elastomers such as natural rubber (NR), polyisoprene (IR), polybutadiene (BD), styrene butadiene copolymer (SBR), acrylonitrile-butadiene copolymer (NBR), and chloroprene (CR) is a well known technique to modify, i.e. reduce, the surface tack without adversely impacting the overall physical and chemical properties of the unsaturated elastomer. Without being limited to any particular mechanism or theory for purposes of this invention it is believed by practitioners that the inherent molecular structure of these unsaturated elastomers (i.e. the presence of double bonds) allows for easy incorporation of chlorine into the elastomer part after vulcanization has been completed. It is also well known by practitioners that post chlorination of saturated elastomers such as butyl rubbers, terpolymers of ethylene-propylene and diene monomers (EPDM) having low diene content (i.e. less than about 5 to 10 percent), and ethylene-propylene rubbers will lead to little or no reduction in surface tack. Thus, it is generally understood by practitioners that halogenatation of unsaturated elastomers is a viable method of reducing surface tack and that halogenatation of saturated elastomers cannot result in any significant reduction in tackiness for a given standard saturated elastomer formulation. However, it is understood that for a given elastomer type, tack can vary as a function of filler, crosslinker, and other component specifics.

It is also understood by practitioners that blending of the two types of elastomers will require a large enough quantity of an unsaturated elastomer, i.e. greater than 50 parts per hundred of rubber, to adversely affect the physical and chemical properties of the saturated elastomer. That is the composition-based averaging of various properties based on the properties exhibited by each cured and halogenated type of elastomer alone leads practitioners to conclude that to significantly reduce the tack of a saturated elastomer one would need considerably more than 50 parts per hundred of rubber of an unsaturated elastomer. Therefore a design engineer generally can hit a road block if the engineer desires to use a saturated elastomer for some desirous property, and the engineer also desires a rubbery material having low surface tack and high volume automated manufacturing capability.

Butyl rubber, which provides excellent barrier properties such as high water and oxygen transmission resistance but also is one of the most tacky elastomers on the market today may advantageously utilize the present invention by blending as little as 15 parts per hundred of rubber or less of an unsaturated elastomer such as polyisoprene, polybutadiene, or a nitrile rubber to significantly reduce the tackiness of the post vulcanization halogenated elastomeric part and; this post halogenation of the elastomer still substantially maintains the beneficial properties of the butyl rubber.

In an alternate embodiment of the present invention, EPDM, which is known for its general purpose use as well as exceptional heat, ozone and oxidation resistance compared to many unsaturated elastomers, but can also suffer from high surface tack. By blending as little as 10 parts per hundred of rubber of an unsaturated elastomer such as polyisoprene, polybutadiene, or a nitrile rubber with the EPDM the present invention advantageously provides post vulcanization halogenated EPDM elastomer parts with significantly reduced tackiness while still maintaining the beneficial properties of the EPDM.

The present invention results from the surprising determination that relatively small amounts of an unsaturated elastomer, as low as 10 parts per hundred rubber (phr) can be added to a saturated elastomer to significantly reduce tack using post vulcanization halogenation. In addition, even smaller amounts as low as 5 phr of an unsaturated elastomer results in a measurable reduction in tack. For a few combinations values as low as just a few phr have been found to lead to a measurable reduction in tack. Small amounts of a nitrile rubber added to an EPDM elastomer has been found to lead to elastomer parts having a greater reduction in surface tack after post vulcanization chlorination when compared to similar blends of EPDM with poly(butadiene) and poly(isoprene). Without intending to be limited by any particular theory or mechanism for purposes of this invention it is noted that the solubility parameters of EPDM, poly(butadiene), poly(isoprene) and nitrile rubber are 17.0, 17.2, 16.6 and 21.0 MPa^{0.5} respectively. It is also noted that solubility between two different components can be expected if the difference in solubility parameter values for the two components is less than about 3.5-4.0 of each other but solubility between the components will be significantly less if the difference in solubility parameters is appreciably larger. See, Fred W. Billmeyer, Jr., Textbook of Polymer Science, Part 3, Chap. 7, page 153 (3rd Ed. John Wiley & Sons, Inc. 1984). Thus, it is believed that the reduction in surface tack is due to the lesser ability for the dissimilar components to mix and therefore a greater concentration of the nitrile rubber segregates, flows and/or blooms to the surface of the elastomer part where it is easily available for halogenation. Thus, the present invention advantageously can utilize unsaturated elastomers that have solubility parameters that are at least 3.5 larger or smaller than the solubility parameter of the saturated elastomer. In those embodiments where larger amounts of the unsaturated elastomer may be used to generate the elastomer blend the solubility parameter of the unsaturated elastomer can approach and even equal the solubility parameter of the saturated elastomer.

In addition, the present invention allows the use of formulations containing either fewer additives and/or the use of less expensive materials and still achieves the desired properties as well as high volume manufacturing requirements. For example, the present invention may be utilized in fluidic devices such as a fluid ejection device. An ink jet printhead assembly utilizes a gasket having slotted ports or holes wherein it is desirable to make the gasket from an elastomer material. The elastomer material should not degrade the ink nor be degraded by the ink, should have sufficient sealing capabilities, and should feed through automated assembly equipment to satisfy high volume production. An EPDM elastomer formulation containing stearic acid as a lubricant was found to have sufficient sealing capability but failed ink testing due to unwanted stearic acid in the ink and also had excessive tack failing to feed through the automated assembly equipment. A non stearic acid EPDM elastomer formulation passed both ink and seal testing but failed in proper feeding through the automated assembly equipment because of high surface tack. However, a non stearic acid EPDM formulation blended with 20 phr of nitrile rubber that was chlorinated after vulcanization functioned similarly to the unchlorinated EPDM elastomer with regards to ink compatibility and seal performance, and in addition, passed the automated assembly equipment feed rate of 400 parts per hour.

It should be noted that the drawings are not true to scale. Further, various elements have not been drawn to scale. Certain dimensions have been exaggerated in relation to other dimensions in order to provide a clearer illustration and understanding of the present invention. In particular, vertical and horizontal scales may differ and may vary from one drawing to another. In addition, although some of the embodiments illustrated herein are shown in two dimensional views with various regions having height and width, it should be clearly understood that these regions are illustrations of only a portion of a device that is actually a three dimensional structure. Accordingly, these regions will have three dimensions, including length, width, and height, when fabricated on an actual device.

Moreover, while the present invention is illustrated by various embodiments, it is not intended that these illustrations be a limitation on the scope or applicability of the present invention. Further, it is not intended that the embodiments of the present invention be limited to the physical structures illustrated. These structures are included to demonstrate the utility and application of the present invention to presently preferred embodiments.

The present invention may utilize elastomer compositions having vulcanizates based on blends of saturated elastomers having little or no unsaturation with highly unsaturated organic elastomers. A saturated elastomer as used in this invention includes any elastomer polymer having 10 percent or less of unsaturated content in the backbone of the polymer. As previously noted the saturated elastomers generally have superior resistance to ozone degradation and consequent cracking, superior resistance to chemical attack, superior temperature stability and similar or superior dynamic damping response. Essentially any saturated elastomer that generally exhibits high tackiness and post vulcanization halogenation that does not significantly reduce the tackiness of the saturated elastomer may be utilized in various embodiments of the present invention. High tack values as used in this invention are relative to the particular saturated elastomer being used. Thus, high tack values include tack values that are similar to the tack values obtained using commercially available vulcanized saturated elastomers such as butyl rubbers (IIR) or EPDM that have not undergone a post vulcanization halogenation treatment and that have low unsaturation content (i.e. less than about 10 percent). On the other hand low tack values as used in this invention are also relative to the particular saturated elastomer being used. Low tack values include tack values that are at least 50 percent lower than the tack values obtained for the vulcanized saturated elastomers that have not undergone a post vulcanization halogenation treatment and that have low unsaturation content (i.e. less than about 10 percent). In at least one embodiment of the present invention saturated organic elastomers that contain a saturated chain of the polymethylene type may be used. Examples of saturated elastomers that may be utilized in the present invention include one or a mixture of low unsaturated elastomers such isobutylene with up to about 10 parts by weight of isoprene commonly referred to as butyl rubber, terpolymers of ethylene-propylene and up to about 10 parts by weight of a non-conjugated diene commonly referred to as EPDM, ethylene-propylene rubbers (EPR), copolymers of a C4 to C7 isoolefins, copolymers of at least one C2 to C8 alpha monoolefin which contain little or no olefinic unsaturation along the polymer chain, halogenated butyl rubber and halogenated interpolymers of a C5 to C7 isoolefin, e.g. isobutylene with up to about 10 weight percent of a para-alkylstyrene such as para-methylstyrene.

In addition to the saturated organic elastomers listed above the present invention may also utilize a saturated or highly saturated elastomeric copolymer having covalently bonded to the polymer backbone an X functional group randomly distributed along and pendant to the saturated elastomer polymer chain. The X functional groups may contain an olefinic or vinyl double bond positioned alpha, or beta to a substituent group which activates the double bond toward free radical addition reactions.

Another suitable class of saturated elastomers that may be utilized in an embodiment of the present invention includes inorganic elastomers such as silicone elastomers generally produced by intermolecular condensation of silanols leading to the formation of silicon-oxygen-silicon or siloxane linkages. Examples of polyorganosiloxanes that may be utilized in various embodiments of the present invention include, but are not meant to be limited to, homo and copolymers one or more siloxane units of the dimethylsiloxane unit, the methyvinylysiloxane unit, the methylfluoroalkylsiloxane unit, the methylphenylsiloxane unit, and the methylethylidenenorbornenesiloxane unit.

A wide variety of unsaturated elastomers may be utilized in the present invention. Essentially any unsaturated organic elastomer that generally exhibits low tackiness after post vulcanization halogenation may be utilized in various embodiments of the present invention. The unsaturated organic elastomer may be a homopolymer of a monomer which polymerizes to a polymer containing a relatively large number of ethylenic unsaturation. A random copolymer of such a monomer with one or more other copolymerizable monomers which may or may not give rise to sites of ethylenic unsaturation in the polymer may be utilized in alternate embodiments. In addition, in still other embodiments the unsaturated organic elastomer may be a block copolymer having two or more discrete segments, one or more of which contain ethylenic unsaturation. Further graft copolymers in which at least one of the backbone or grafted chains contain ethylenic unsaturation also may be utilized in various embodiments. Examples of unsaturated elastomers that may be utilized in various embodiments include natural rubber, synthetic poly(isoprene) rubber, polybutadiene, styrene butadiene rubber, chloroprene, and nitrile rubbers.

Examples of unsaturated organic elastomers, that may be utilized in various embodiments of the present invention, include the homopolymers and interpolymers of conjugated dienes such as poly(butadiene), poly(isoprene), poly(1,4-hexadiene) as just a few examples. These conjugated dienes also may optionally include substituent groups such as alkyl groups or halogen atoms. Chloroprene or 2-chloro-1,3 butadiene is just one example of a halogenated conjugated diene. These polymers typically contain residual carbon carbon double bonds on the polymer backbone, with approximately one carbon carbon double bond per repeating unit of the homopolymer. Random copolymers of conjugated dienes with at least one other copolymerizable monomer that also contains ethylenic unsaturation may also be used. Examples of such monomers includes alkenes such as ethylene, propene, n-butylene, isobutylene as well as others. In addition, monomers of vinyl aromatics such as styrene, vinyltoluene, t-butylstyrene, and vinylnaphthalene as well as others may also be used. Monomers of acrylic esters such as alkyl acrylates, and alkyl methacrylates as well as monomers of halogenated alkenes such a vinyl chloride, vinylidene chloride, vinyl bromide, and vinylidene bromide, and acrylamide also may be used. Homopolymers and copolymers of bicyclic dienes such as dicyclopentadiene or norbornene also may be utilized as well as terpolymers of ethylene or propylene or both with bicyclic dienes are also suitable. The polypenteneamers such as polymers of cyclopentene and homologs thereof are also suitable. In at least one embodiment the nitrile rubbers which are random copolymers of butadiene and acrylonitrile as well as styrene-butadiene elastomers also may be used. Further, block copolymers of styrene and a conjugated diene, such as styrene/isoprene block copolymers or styrene/isoprene triblock copolymers also may be utilized.

While the elastomer composition of the present invention is primarily composed of the combination of the saturated elastomers and unsaturated organic elastomers the elastomer composition may also include a wide variety of additives that are commonly used in the rubber industry. The following list of various types of additives is for illustrative purposes only and is not meant to be limited soley to the compounds or types of additives listed. Reinforcing fillers, and extenders may also be used which includes both organic and inorganic fillers and extenders. Inorganic fillers such as fumed silica, wet processed silica, fine quartz powder, diatomaceous earth, carbon blacks, titanium dioxide, talc, white zinc, magnesium carbonate, magnesium silicate, aluminum silicate, aluminum sulfate, calcium carbonate, calcium metasilicate, calcium sulfate, mica powder, barium sulfate, glass fibers, as well as organic reinforcements and organic fillers such as phenolic resins, styrene resins, coumarone-indene resin, lignin, modified melamine resins and petroleum based resins. Antioxidants such as phenylenediamines, phosphates, quinolines, cresols, phenols, and metal salts of dithiocarbamate may be added. Inert diluents such as ethylbenzene, toluene, and diethylbenzene may be used. Dispersing aids such as higher weight fatty acids and metal salts or amide salts of fatty acids also may be used. Plasticizers such as phthalic acid derivatives, adipic acid derivatives, trimethylsilanol, polydimethylsiloxane oil, diphenylsilanediol, hydrocarbon oils, and phosphoric acid type plasticizers may be added. Softening agents or lubricants can include fatty oil type lubricants such as linseed oil, rapeseed oil, castor oil, and coconut oil; petroleum-type lubricants such as coal tar, process oils, mineral oils, and paraffins; waxes such as, carnuba wax, beeswax, and lanolin; fatty acids and fatty acid salts such as palmitic acid, calcium stearate, linoleic acid, barium stearate, and zinc laureate also may be added. Heat stabilizers such as cerium oxide, iron naphthenate, iron oxide, potassium hydroxide, and potassium naphthenate also may be added. Finally other additives can include ultraviolet light absorbers, colorants, tackifiers, and flame retardants as just a few additional examples.

The vulcanizable composition may be blended using any suitable mixing device such as an internal mixer, a Banbury mixer, a mill mixer, a kneader, or any other similar mixing device. Blending temperatures and times may range from about 25° C. to about 200° C. and from about 5 minutes to about 20 minutes respectively. After forming a homogenous mixture of the saturated and unsaturated elastomers and the optional additives the mixture or masterbatch is further mixed with various cross linking agents and accelerators. After the elastomer composition has been properly mixed it is shaped for molding, calendaring, extrusion or fabrication into a composite structure. Compression molding, transfer molding, and injection molding are a few examples of molding techniques that can be used to create finished articles. Which ever technique is utilized to form the finished article the resulting blend is heated to a temperature in the range from about 25° C. to about 200° C. for a period of time in the range from about 1 minute to about 120 minutes to vulcanize the elastomer part. Both thermoplastic as well as thermoset elastomer blends may be utilized in the present invention. In regards to the present invention vulcanization includes any treatment that decreases the flow of the elastomer blend, increases its tensile strength and modulus, but substantially preserves the elastomer blends extensibility. See, Fred W. Billmeyer, Jr., Textbook of Polymer Science, Chap. 19, page 359 (2nd Ed. John Wiley & Sons, Inc. 1971).

Sulfur is probably the most common agent used to vulcanize an elastomer and may be used in the present invention. However, other vulcanizing agents also may be utilized such as metal oxides, difunctional compounds, or peroxides as well as mixtures or combinations of these agents. Zinc oxide reacts with and therefore is one example of a compound that may be used to crosslink carboxylated nitrile rubbers, butadiene, styrene-butadiene rubbers, and chloroprenes. Lead oxide, magnesium oxide, and magnesium oxide/pentaerythritol also may be utilized to cross link these rubbers. Epoxy resins are an example of a difunctional compound that, for example, may be utilized to crosslink nitrile rubbers. Quinone dioximes are examples of compounds that may be used to crosslink butyl rubbers. Fluororubbers may be crosslinked using, for example, diamines and dithio compounds. A wide variety of organic peroxides may be utilized to vulcanize saturated elastomers that either do not contain or contain very few reactive groups to form crosslinks. Organic peroxides generally produce radicals which form carbon carbon bonds between adjacent polymer chains.

Vulcanization compounds which may be used as crosslinking agents in the present invention include elemental sulfur or mixtures of sulfur and sulfur-containing accelerators. In addition, phenol-formaldehyde resins either alone or in combination with sulfur may also be used. Examples of sulfur compounds that can be utilized in the present invention, but are not meant to be limitive, include benzothiazyl disulfide; alkyl phenol disulfides; alkyl-thiuram sulfides such as dipentamethylene thiuram tetrasulfide, tetrabutylthiuram disulfide, tetraethylthiuram disulfide, tetramethylthiuram monosulfide, tetrabenzyl thiuram disulfide, and mixtures thereof; m-phenylenebismaleimide; 2-mercaptoben-zothiazole; N-oxydiethylene benzothiazole-2-sulfenamid; N,N-diarylguanidines; diaryl-dithiocarbamates of zinc, bismuth, cadmium, copper, lead, selenium, tellurium, and mixtures thereof; dialkyldithiocarbamates of zinc, bismuth, cadium, copper, lead, selenium, and tellurium wherein the alkyl group contains from 1 to 5 carbon atoms, piperidinium pentamethylenedithiocarbamate as well as mixtures of these dialkyldithiocarbamates; and other similar sulfur compounds.

These sulfur containing crosslinking agents and accelerators are generally added to the elastomer blend composition in amounts ranging from about 0.5 percent to about 8 percent by weight, based on the weight of elastomer present in the composition. These compounds can also be used as part of a sulfur curing system which includes a co-curative compound such as zinc oxide or an equivalent of zinc oxide. In those embodiments using a co-curative agent such as zinc oxide, it is generally added in an amount in the range from about 0.2 to about 7 parts by weight per 100 parts by weight of elastomer.

Peroxides that may be utilized include the general categories of peroxides such as dialkyl peroxides, peroxyethers, ketal peroxides, peroxyesters, and aralkyl peroxides. The following list is meant for illustrative purposes only and is not intended to limit the present invention to the peroxides listed. Examples of particular peroxides includes di-cumyl peroxide, benzoyl peroxide, di-tert-butyl peroxide, di-t-butylperoxy isophthalate, p-chlorobenzoyl peroxide, tert-butylperbenzoate, 2,5-di(t-butylperoxy)hexyne-3, t-butylperoxy benzoate, 1,1-bis(t-butylperoxy)-3,3,5-trimethylcyclo-hexane, 2,5-dimethyl-2,5-di(t-butylperoxy)hexane, 2,2′-bis(t-butylperoxy)-p-diisopropyl-benzene, and 2,4-dichlorobenzoyl peroxide, p- and. Of these compounds 2,2′-bis(t-butylperoxy)-p-diisopropyl-benzene, 2,5-dimethyl-2,5-di(t-butylperoxy)hexyne, and benzoyl peroxide may be used to crosslink saturated silicone rubbers. The particular amount of crosslinker used will vary depending on various factors such as the particular elastomers utilized and the degree of crosslinking desired. Generally the amount of peroxide used will be in the range from about 0.1 to about 10 parts by weight. Typically if the amount of crosslinker utilized is less than about 0.1 part by weight, the density or number of crosslinks formed in the final elastomer part is too low to provide satisfactory compression set characteristicsm, mechanical strength, and creep resistance. In addition, typically it is also found that if the amount of crosslinker utilized is greater than about 10 parts by weight, the density or number of crosslinks formed in the final elastomer part is too high resulting in a material that will not exhibit the degree of elongation desired. In addition other crosslinking aids also may be employed. For example, bifunctional vinyl monomers are just one example of a crosslinking aid that may be utilized. N,N′-methylenebisacrylamide, bismaleimide, ethylene dimethacrylate, 2,2′-bis(4-methacryloyldiethoxyphenyl)propane, polyethylene glycol dimethacrylate, divinylbenzene, pentaerythritol triacrylate, 1,4-butylene dimethacrylate, p,p′-dibenzoyl quinone dioxime, triallyl isocyanurate, 1,6-hexanediol diacrylate, triazine dithiol, p-quinone dioxime, triallyl cyanurate, 1,3-butylene dimethacrylate, 1,6-hexanediol dimethacrylate, trimethylolpropane trimethacrylate, 1,4-butanediol diacrylate, and trimethylolpropane triacrylate are just a few examples of crosslinking aids that may be utilized in the present invention.

General techniques and compositions for post chlorination of elastomers are well known in the literature. Chlorination can be done as a batch process, for example, by treating the elastomer parts in the range from about 3 minutes to about 30 minutes at about 60° C. using a muriatic acid and bleach or Pool Pro solution. Commercial chlorinators can also be used in which water and chlorine gas are mixed for a known time and temperature. The chlorine and pH levels may be monitored during the chlorination process.

The elastomer composition of the present invention exhibits good low tack performance without the use of powders. As a result of this low tack the post halogenated vulcanized rubber product of this elastomer composition is applicable to the general rubber industry.

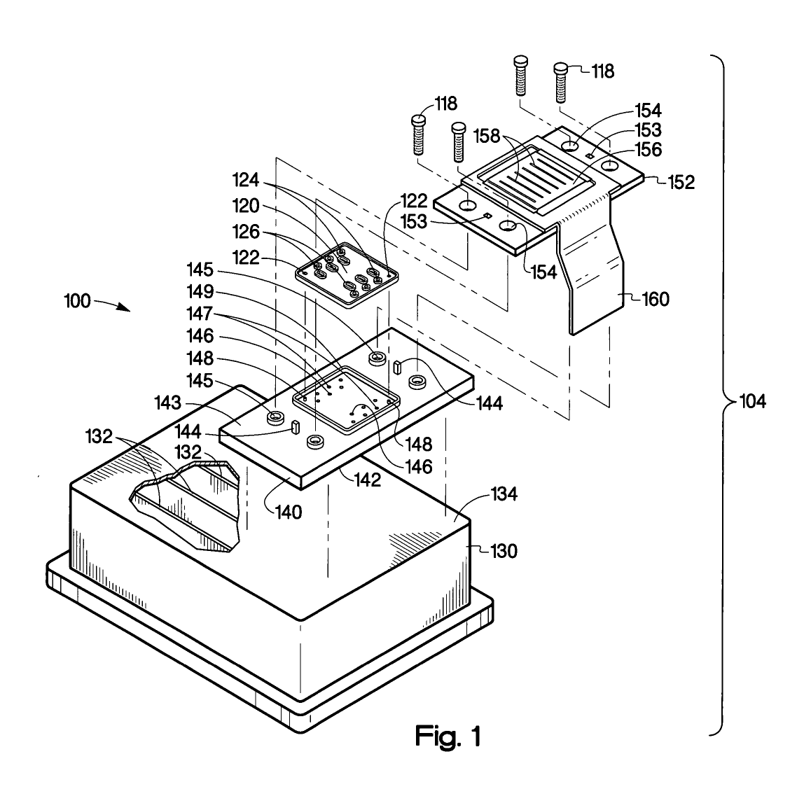

An exemplary embodiment of the present invention is a fluidic device shown, in an exploded perspective view, in FIG. 1a. In this embodiment, fluidic device 100 is a fluid ejection device that includes fluid ejector head assembly 104 that utilizes elastomer gasket 120 that is made using an elastomer composition of the present invention. Fluid ejector head assembly 104 also includes fluid container 130 that stores the fluid that is to be ejected from fluid ejector die 156. Depending on the particular application in which the fluidic device will be utilized the fluid container may be configured to store a single fluid or multiple fluids. In the particular embodiment shown in FIG. 1a fluid container 130 is partitioned into 6 compartments by compartment separators 132 where each compartment holds a different color ink. In alternate embodiments fluid container 130 may include a single compartment to hold a desired fluid or the fluid container may include multiple compartments to hold either a single fluid or multiple fluids.

The fluid ejector head assembly also includes fluid manifold 140 providing fluidic pathways to route the fluids stored in the fluid container to the desired fluid ejectors disposed on fluid ejector die 156. In the embodiment in FIG. 1a, a recirculation pump (not shown) is used to pump fluid from each compartment to the fluid ejector die and back to the reservoir. Thus, in this embodiment fluid container 130 includes a fluid inlet (not shown) and fluid outlet (not shown), formed on or in manifold mating surface 134 of fluid container 130, for each compartment formed in the fluid container. Likewise fluid manifold 140 includes a fluid inlet (not shown) and fluid outlet (not shown) formed on or in fluid container mating surface 142 of fluid manifold 140. In alternate embodiments, a wide variety of fluid routing structures or paths also may be utilized. For example, in those embodiments that do not use a recirculation pump a single outlet for each compartment may be used. In those embodiments where mixing of the fluids prior to ejection is either desirable or is at least not detrimental various combinations of compartments may use a common fluidic path thereby reducing the number of fluid inlets and outlets.

In the embodiment shown in FIG. 1a fluid container 130 is injection molded using glass filled polypropylene and fluid manifold 140 is formed from polypropylene. In this embodiment, fluid container mating surface 142 of fluid manifold 140 is laser welded to manifold mating surface 134 of fluid container 130. In alternate embodiments, a wide variety of polymers, metals, glasses, or ceramics may be utilized to form fluid container 130. The particular material chosen will depend on a number of variables including the fluid or fluids to be stored within the fluid container and the environment in which fluidic device 100 will be utilized. Likewise fluid manifold 140 also may be formed from a wide variety of polymers, metals, glasses, or ceramics and will again depend on a number of variables including the fluid or fluids utilized and the environment in which the fluidic device will be utilized. In addition, a wide variety of attachment techniques also may be utilized including for example mechanical fastening, heat staking, and adhesive bonding.

Fluid manifold 140, in this embodiment, also includes die chip carrier alignment pins 144 formed on die chip carrier mating surface 143, to match alignment holes 153 formed in the die chip carrier to ensure alignment of the fluid inlet and outlet channels of the manifold with the fluid inlet and outlet channels of the die chip carrier. In this embodiment, screws 118 are used for attaching die chip carrier 152 to the manifold through screw holes 154 formed in the die chip carrier and securing the screws in threaded screw holes 145 formed in the manifold. The fluid manifold also includes gasket retaining structure 149 formed on die chip carrier mating surface 143 for retaining or holding in place elastomer gasket 120. In addition, the fluid manifold includes gasket alignment pins 148 to match gasket alignment holes 122 formed in the elastomer gasket. When die chip carrier 152 is securely fastened to fluid manifold 140 manifold fluid outlets 146 and manifold fluid returns 147, formed in die chip carrier mating surface of the fluid manifold, are aligned with gasket fluid outlet 126 and gasket fluid return 124 respectively. On the manifold mating surface of die chip carrier 152 fluid inlets (not shown) and outlets (not shown) are also in alignment with the manifold and gasket fluid outlets and returns such that fluid may continuously flow out of a particular compartment in the fluid container to the fluid ejector die 156 and flow back to the same compartment. In an alternate embodiment the fluid may be routed such that fluid flows from a particular compartment in the fluid container to the fluid ejector die and then flows back to a different compartment. In addition, as noted earlier for those embodiments that do not utilize recirculation a single channel or pathway supplying fluid from a particular compartment to the fluid ejector die also may be used.

Fluid ejector die 156, in this embodiment, includes a substrate on which fluid ejector actuators (not shown) are formed. The fluid ejector actuators generate the force necessary for ejecting the fluid from fluidic device 100. Two widely used actuator elements are thermal resistors and piezoelectric elements. The former rapidly heats a component in the fluid above its boiling point causing ejection of a drop of the fluid. The latter utilizes a voltage pulse to generate a compressive force on the fluid resulting in ejection of a drop of the fluid. In addition, typically a chamber (not shown) is formed around the fluid ejector actuators to contain a desired amount of fluid. Over each chamber generally one or more nozzles (not shown individually) is formed through which the fluid is ejected. For those applications desiring accurate placement of the ejected drops onto a receiving media, such as for printing applications, the nozzles are typically formed in a row or line 158. This row or line of nozzles may be formed in a straight line or in various staggered configurations based on the desired drop volume and desired spacing between ejected drops deposited onto the receiving media. Fluidic device 100 also includes electrical interconnect 160 that provides for routing of electrical signals from a controller (not shown) to the fluid ejector die.

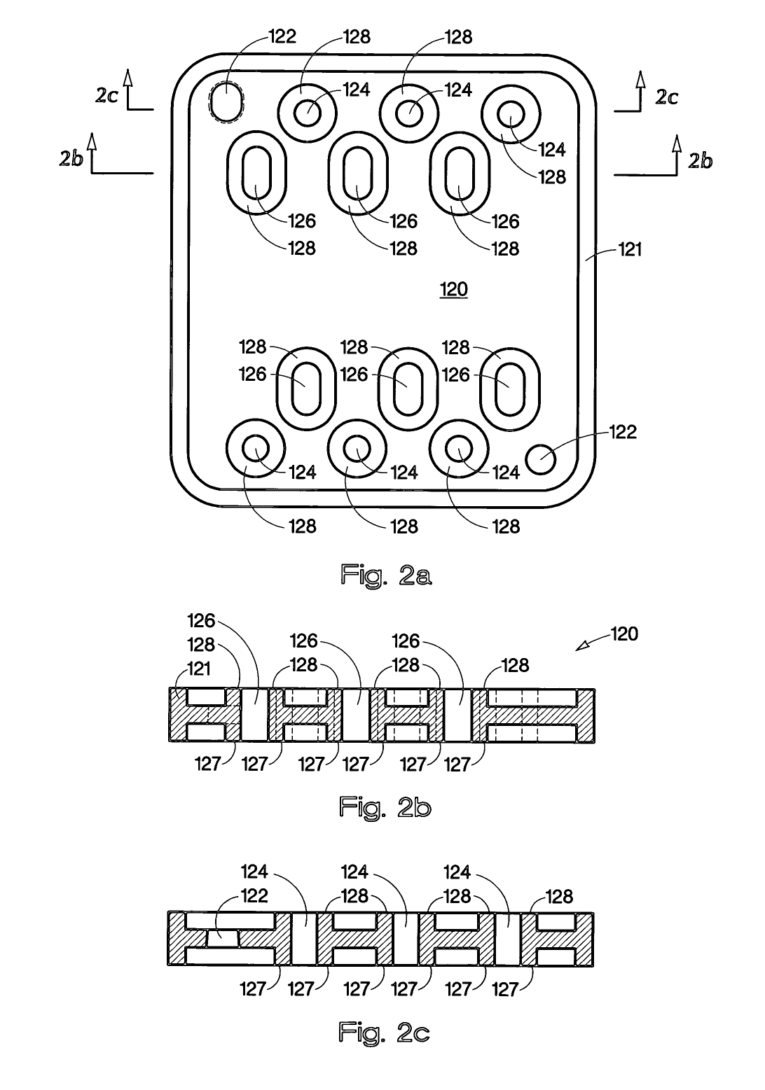

The elastomer gasket shown in a perspective view in FIG. 1a is shown in a plan view in FIG. 2a. Elastomer gasket 120, in this embodiment, includes gasket rim 121 providing for more uniform compression during sealing, enhanced sealing at the perimeter, and provides additional structural support for the gasket. As described above alignment holes 122 are positioned to match the gasket alignment pins formed in the fluid manifold. The raised portion of the gasket formed around each gasket fluid outlet 126 and gasket fluid return 124 acts as a sealing surface. As illustrated in the cross-sectional views shown in FIGS. 2a and 2b these raised portions are formed on both sides of the elastomer gasket and form manifold sealing surfaces 127 and die chip carrier sealing surface 128 so that when the gasket is compressed between the fluid manifold and the die chip carrier a reliable seal is made between all of the fluid pathways extending from the fluid manifold to the die chip carrier. In this embodiment, elastomer gasket 120 includes 80.0 parts per hundred rubber (phr) of an EPDM rubber commercially available from The Dow Chemical Company under the name Nordel IP 4570 containing 50 percent ethylene, 45 percent propylene and 5 percent ethylidenenorbornene and 20.0 phr of a nitrile rubber commercially available from Zeon Corporation under the name Nipol NBR DN2850 which is a medium nitrile rubber containing 28.0 weight percent bound acrylonitrile. In addition, the gasket also includes 8.0 phr of an organic peroxide crosslinker available from GEO Specialty Chemicals Inc. under the name Vul-Cup 40KE which consists of approximately 40 percent active bisperoxide supported on Burgess KE clay. Vul-Cup 40KE is a mixture of the para and meta isomers of an alpha, alpha′bis(ter-butylperoxy)-diisopropylbenzene. Carbon black in the range from about 9.0 to 15.0 phr is also added as a reinforcing filler. In this embodiment, the carbon black is available from Columbian Chemicals Company under the designation N330. In addition a similar carbon black is available from Cabot Corporation. 20 phr of a plasticizer oil is also added. The oil, in this embodiment, is available from Sunoco Inc. under the name Sunpar 2280 which is a paraffinic oil. 2.0 phr of a processing aid is also added to the blend. The processing aid is available from The Dow Chemical Company under the name Carbowax Sentry 3350 which is a polyethylene glycol with an average molecular weight between 3015 to 3685.

The vulcanizable composition may be prepared and blended using any suitable mixing device such as an internal mixer (Brabender Plasticorder), a Banbury Mixer, a mill mixer, a kneader or a similar mixing device. The actual compounding and mixing was done using an internal mixer. Blending temperatures and times may range from about 80° C. to 120° C. and 3-15 minutes respectively. Fillers and other non-cure system additives were added during the internal mixer phase and cure system additives were added to the compound during the two roll mill mixing phase at a temperature of 25° C. to 80° C. for a period of 3-15 minutes. After forming a homogeneous mixture of the elastomers and optional fillers, processing aids, antioxidants and the like, the mixture is then vulcanized by heating the resulting blend to a temperature of from about 100° C. to 240° C. for a period of time ranging from about 1 to 10 minutes. In some embodiments, the mixture can be vulcanized by heating to a temperature in the range from about 150° C. to about 230° C.

The post vulcanization chlorination process included 900 pounds per day chlorine level and 1429 parts per million titration value. The elastomer was found to have an R value (repeat units/crosslink) of 20-60 using an 80/20 volume ratio of a hexane-acetone solvent system. The specific gravity was measured in the range for 0.94 and 1.00. The hardness (Shore A) was found to be in the range from 46 to 56 with a minimum tensile strength of 600 psi, and a tensile elongation between 100 percent and 500 percent. In automated assembly feeding tests the unchlorinated EPDM fed at about 350 parts per hour, which was well below the desired feed rate, while the post vulcanized chlorinated EPDM/nitrile rubber blend fed at more than 475 parts per hour, which was well above the desired feed rates.

In addition, the samples were analyzed by x-ray photoelectron spectroscopy (XPS) using a Physical Electronics QUANTERA Scanning ESCA system. Analysis areas were located using a secondary electron image generated from the scanning photon beam. A 100 W, monochromated aluminum X-ray (1486.7 electron volts) was used to probe a 200 micrometers by 1200 micrometers area on each sample. All spectra were charge corrected to carbon 1s, 284.8 electron volts. Atomic concentrations were calculated from established elemental sensitivity factors [RSF] and are considered semi-quantitative. XPS does not detect hydrogen and the typical analysis depth is less than or equal to 70 Å. Before post vulcanized chlorination, the blend surface and bulk material each had less than 0.1 atomic percent chlorine. After chlorination, the surface of the elastomer blended part, i.e. the exterior surface had 1.2-3.0 atomic percent chlorine while the bulk material continued to have less than 0.1 atomic percent chlorine using XPS. Thus, after chlorination the elastomer part has a chlorine concentration gradient that decreases from the outer or exterior surface of the part to the interior bulk region of the elastomer part. Without being limited to any particular mechanism or theory for purposes of this invention it is that the reduction in surface tack for the post vulcanized halogenated part is due to the lesser ability for the dissimilar components to mix leading to a greater concentration of the nitrile rubber segregating, or blooming to the surface of the elastomer part where it is easily available for halogenation.

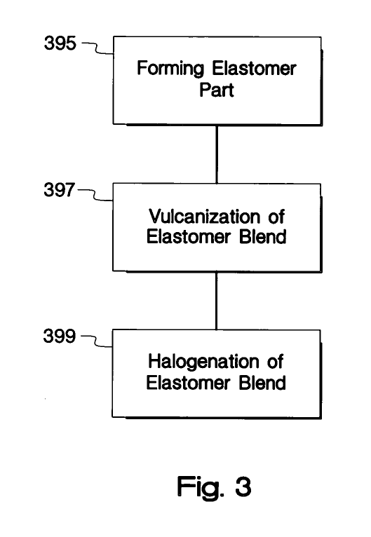

A flow diagram of a method of making an elastomer part according to an embodiment of the present invention is shown in FIG. 3. In this embodiment, forming process 395 is utilized to form a tacky elastomer blend part by utilizing a wide variety of techniques such as molding, extrusion or fabrication into a composite structure. Compression molding, transfer molding, and injection molding are a few examples of molding techniques that can be used to create finished articles. After the elastomer part is formed vulcanizing process 397 is utilized to heat the elastomer part to vulcanize it. As previously discussed sulfur as well as metal oxides, difunctional compounds, and peroxides may all be utilized to vulcanize the elastomer part. Essentially any technique that leads to vulcanization may be utilized in this embodiment. After vulcanization is complete halogenation process 399 is used to halogenate essentially the unsaturated portion of the elastomer blend that has migrated or bloomed to the surface. Generally a chlorination process is utilized, however, in other embodiments bromination, fluorination, and/or iodination of the elastomer blend also may be used.

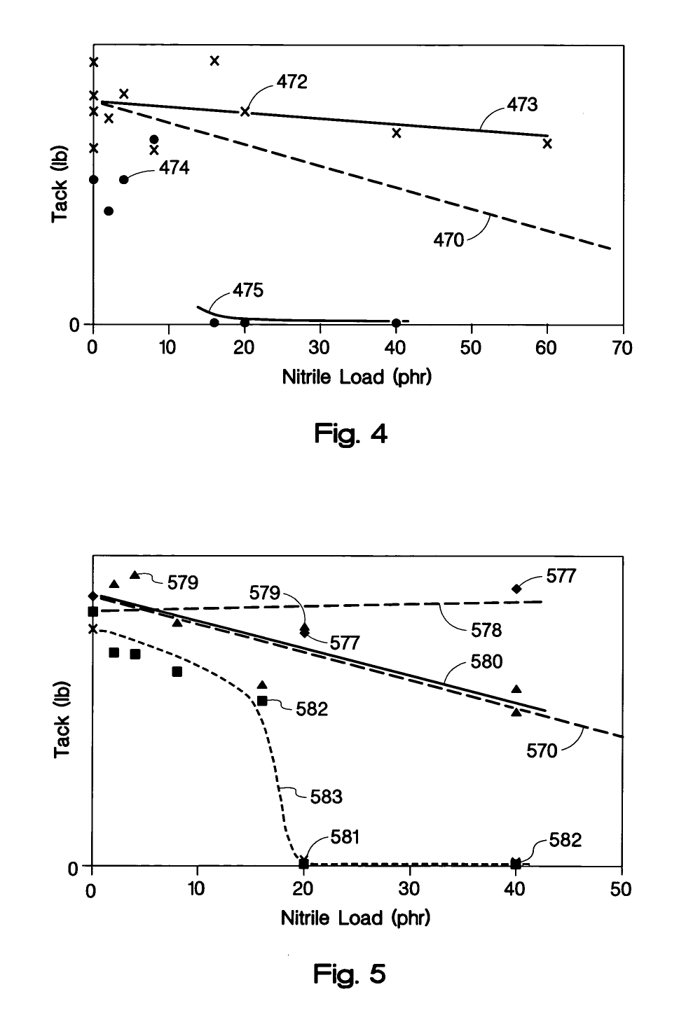

FIGS. 4-6 show the effect of post vulcanization chlorination on a number of elastomer blends and are illustrative of the present invention. The compounding and mixing for all of the blends shown in FIGS. 4-6 was done using a 0.5 lb approximate batch weight internal mixer followed by a finishing operation on a two roll mill. Fillers, zinc oxide, stearic acid, antioxidants and other non-cure system additives were added during the internal mixer phase and cure system additives were added to the compound during the two roll mill mixing phase.

Subsequent to the mixing process, the cure characteristics for each of the experimental elastomer blends was determined using an R100 Monsanto oscillating disk rheometer (ODR). The cure temperature selected for all experimental elastomer blends was 160° C. The cure time for all materials studied was calculated from the ODR curves at a value of approximately T_{95.} T₉₅ correlates to the elapsed time during which the rubber advances to a value of 95% of the lowest to the highest elasticity as measured by the elastic torque of the sample.

Test samples of the elastomer blends were prepared at a cure temperature of 160° C. and a cure time of T₉₅ (2 times T₉₅ for compression set samples) that included 0.079″ by 6″ by 6″ test slabs (tensile, tear, shore A testing) compression set buttons and 0.020″ by 4″ by 4″ test slabs (DMTA, permeability testing).

Tensile properties, tear energy, shore A hardness, compression set and resiliency testing was performed according to ASTM methods D412, D624, D2240, D390 and D2632.

Tack test data was generated using special test samples or buttons molded specifically for this test. Two test samples from the same mold are required for each tack test. One of the samples is loaded and fastened into the lower, rigid support mechanism of the tensile test machine with a quarter sized flat round surface exposed. The support mechanism encases the sample except the exposed test surface. The other sample is loaded and fastened into the upper, support mechanism with similar quarter sized flat round top and bottom surfaces exposed. The upper fixture is then attached to the crosshead of a tensile test machine and the top sample is lowered until it makes contact with the exposed surface of the bottom sample. A 3 Kg weight is placed on the upper sample and allowed to remain for one minute. Then, the weight is removed and the upper support mechanism pulls away from the bottom sample at a crosshead speed of 0.1 inches per minute. The force is recorded until the samples completely separate. The maximum in the force to failure load curve is reported as the relative tack value. To keep the test samples or buttons from being contaminated the samples were molded with a PET sheet over the test face of the sample.

FIG. 4 summarizes the results of blending a butyl rubber elastomer with a nitrile rubber N917 where the amount of nitrile rubber was varied from 0 phr to 60 phr. In this particular embodiment the butyl rubber is Exxon Bromobutyl 2222 available from ExxonMobil Chemical, a brominated copolymer of isobutylene and isoprene with a 2.0±0.2 weight percent bromine, the nitrile rubber is a 26-30% or low acrylonitrile content Chemigum N917 available from The Goodyear Tire and Rubber Company. All formulations in the figure contain N550 carbon black at 45 phr, stearic acid at 1 phr, zinc oxide at 5 phr, 2,2 dithiobisbenzothiazole (MBTS) at 2 phr, and tetramethylthiuram disulfide (TMTD) at 1 phr. The butyl rubber used was Exxon Bromobutyl 2222, the nitrile rubber is N917 as described above, and their appropriate phr proportions are provided in the figure. In FIG. 4 the data points denoted by—x—reference number 472 illustrate the effect of nitrile loading without chlorination on tack. Line 473 is the least squares fifted line to the data points 472. Both data points 472 and line 473 show that there is little if any change in tack upon addition of the nitrile rubber.

The data points—●—reference number 474 illustrate the effect of chlorination on tack. Line 475 is a hand drawn line to help the reader visualize the trend in the data points 474 and is not meant to imply any fitting of the data points to a particular curve. The chorination is performed by submersing the tack sample buttons in a mixture of 78% water, 7% muriatic acid and 15% pool bleach for 30 minutes at 60° C. Line 470 shown in FIG. 4 represents the linear reduction in tack upon chlorination of a blend of a saturated elastomer with an unsaturated elastomer where at 0 phr line 470 represents the average tack for the butyl rubber and 100 phr (not shown) would represent the low essentially 0 tack expected from chlorination of an unsaturated elastomer. Thus, at 50 phr one would expect to see approximately a 50 percent reduction in tack compared to the 100 percent butyl rubber. However, line 470 ignores the effect of chlorination on the butyl rubber alone; but, even if this is taken into account by looking at the first data point 470 at 0 phr nitrile loading one sees that there is only about a 10-15 percent drop in tack due to chlorination of the unloaded butyl part by itself. In contrast, the data points 474 indicate that at least for 15 phr of nitrile rubber and above one obtains the surprising result essentially of completely reducing the tack of the butyl rubber elastomer blend part to zero. It is clear from the figure that the compounds containing nitrile rubber show lower tack values after post vulcanized chlorination when compared to those containing only butyl rubber and butyl nitrile blends that were not post chlorinated. Even at low nitrile loading below 15 phr a reduction in tack is observed. Such a reduction in tack provides the practitioner with the ability to formulate elastomer blends that advantageously utilize some desired property of a saturated elastomer with only a minimal reduction of that desired property due to the addition of a small amount of the unsaturated elastomer. The practitioner also obtains a low tack elastomer part that is free from powder contamination and obtains an elastomer part that can be used on automated high speed assembly equipment.

FIG. 5 shows the same phenomena of significant tack reduction when postchlorinated butyl nitrile blends are created using two different nitrile grades N608, a 30-34% or medium acrylonitrile content Chemigum N608 nitrile grade available from The Goodyear Tire and Rubber Company and N917 blended with Exxon SB Bromobutyl 6222 available from ExxonChemical, a brominated copolymer of isobutylene and isoprene with a 2.4±0.2 weight percent bromine. All formulations in the figure contain N550 carbon black at 45 phr, stearic acid at 1 phr, zinc oxide at 5 phr, MBTS at 2 phr, TMTD at 1 phr, and sulfur at 0.2 phr. In FIG. 5 the data points denoted by—♦—reference number 577 illustrate the effect of nitrile N917 loading without chlorination on tack. Line 578 is the least squares fitted line to the data points 577. Similar to the no chlorination data shown in FIG. 4 both data points 577 and line 578 show that there is essentially no change in tack upon addition of the nitrile rubber to the butyl rubber 6222 without chlorination. However, the data points denoted by—▴—reference number 579 show the effect of nitrile N608 loading without chlorination on tack, and line 580 is the least squares fitted line to the data points 579. Unlike the previous two examples the addition of nitrile rubber N608 to butyl rubber 6222 does result in a reduction in tack of approximately 40 percent. Line 570 is similar to that shown in FIG. 4 and again represents the linear reduction in tack if the reduction in tack is the average of the amount of the two elastomer components blended together. The addition of nitrile rubber N608 to the butyl rubber 6222 results in a reduction in tack approximately the same as that expected for the average of the two components.

The data points denoted by—x—reference number 581 show the effect of chlorination on tack for nitrile rubber 917 and the data points denoted by—▪—reference number 582 shows the effect of chlorination on tack for nitrile rubber 608. Line 583 is a hand drawn line to help the reader visualize the trend in both data points 581 and 583 and is not meant to imply any fitting of the data points to a particular curve. It is clear from the figure that both elastomer blends of nitrile rubber N608 and N917 show lower tack values after post vulcanized chlorination when compared to those containing only butyl rubber and butyl nitrile blends that were not post chlorinated. As described above even taking into account the observed reduction in tack for the 0 phr nitrile rubber samples the ability to essentially reduce tack to zero is surprising for as little as 20 phr of nitrile rubber. Even at low nitrile loading below about 20 phr a reduction in tack is observed.

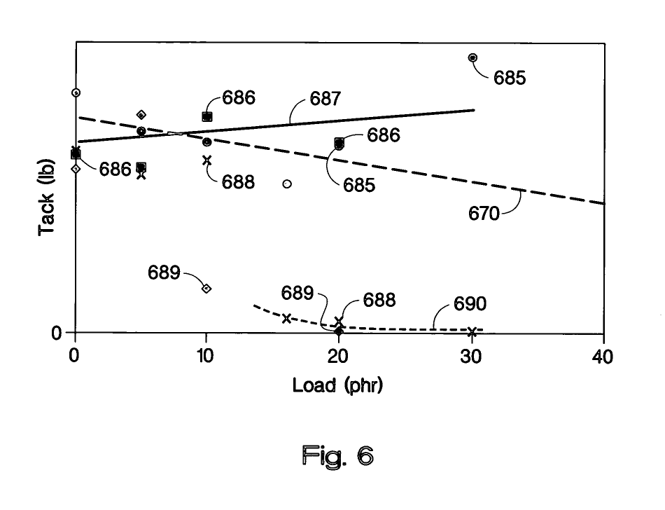

FIG. 6 again shows the same phenomena of significant tack reduction when postchlorinated blends of butyl rubber 6222 with butyl polyisoprene or butyl polybutadiene are created. The appropriate phr proportions are provided in the figure for the Exxon SB Bromobutyl 6222, the polyisoprene grade 2200 available from The Goodyear Tire and Rubber Company sold under the name Natsyn 2200, and the polybutadiene from Lanxess AG sold under the name Taktene used in the elastomer blends. All formulations in the figure contain N550 carbon black at 45 phr, stearic acid at 1 phr, zinc oxide at 5 phr, MBTS at 2 phr, TMTD at 1 phr, and sulfur at 0.2 phr. In FIG. 6 the data points denoted by—●—reference number 685 illustrate the effect of polyisoprene loading without chlorination on tack. The data points denoted by—▪—reference number 686 illustrate the effect of polybutadiene loading without chlorination on tack. Line 687 is a hand drawn line to help the reader visualize the trend of both data points 685 and 686 and is not mean to imply any fitting of the data points to a particular curve. Similar to the no chlorination data shown in FIG. 4 and the unchlorinated nitrile N917 data shown in FIG. 6 both data points 685 and 686 shown that there is essentially no reduction in tack upon addition of either a polyisoprene or polybutadiene elastomer to elastomer parts having greater than 50 phr of the butyl rubber 6222.

The data points—x—reference number 688 show the effect of chlorination on tack for butyl rubber 6222 blended with polyisoprene, and the data denoted by —♦—reference number 689 show the effect of chlorination on tack for butyl rubber 6222 blended with polybutadiene. Line 690 is a hand drawn line to help the reader visualize the trend in both data points 688 and 689 and is not mean to imply any fitting of the data points to a particular curve. It is clear from the figure that both elastomer blends using either a butyl polyisoprene or a butyl polybutadiene blend shows lower tack values after post vulcanized chlorination when compared to those containing only butyl rubber and the unsaturated elasomers that were not post chlorinated. Line 670 is similar to that shown in FIGS. 4 and 5 and again represents the linear reduction in tack if the reduction in tack is the average of the amount of the two elastomer components blended together. Again even taking into account the observed reduction in tack for the 0 phr polyisoprene or polybutadiene samples the ability to essentially reduce tack to zero is surprising for as little as 20 phr of either the butyl polyisoprene or the butyl polybutadiene elastomer blend. Even at low loading below about 20 phr a reduction in tack is observed. For the polybutadiene elastomers as little as 10 phr reduces tack by approximately 75 percent.

What is claimed is:

1. An elastomer composition, comprising a mixture of:
at least 50 parts per hundred rubber (phr) of a saturated elastomer;
less than 50 parts per hundred rubber of an unsaturated elastomer, wherein the mixture is halogenated after vulcanization producing an elastomer material having a tack at least 60 percent lower than a saturated tack of a composition having said saturated elastomer mixed with between about 40 phr and about 50 phr of said unsaturated elastomer, wherein said composition is vulcanized but not post vulcanization halogenated.

2. The elastomer composition in accordance with claim 1, wherein said elastomer material further comprises a halogen concentration gradient that decreases from an exterior surface of said elastomer material to a central interior region of said elastomer material.

3. The elastomer composition in accordance with claim 1, wherein said saturated elastomer further comprises said saturated elastomer having a first solubility parameter, and wherein said unsaturated elastomer further comprises said unsaturated elastomer having a second solubility parameter, wherein the difference between said first and said second solubility parameters is at least 3.5.

4. The elastomer composition in accordance with claim 1, wherein said at least 50 parts per hundred rubber of said saturated elastomer further comprises at least 75 phr of said saturated elastomer, and wherein the less than 50 parts per hundred rubber of said unsaturated elastomer further comprises less than 25 phr of said unsaturated elastomer.

5. The elastomer composition in accordance with claim 1, wherein the less than 50 parts per hundred rubber of said unsaturated elastomer further comprises said unsaturated elastomer in the range from about 10 phr to about 20 phr.

6. The elastomer composition in accordance with claim 1, wherein said saturated elastomer further comprises said saturated elastomer having a saturated polymer, wherein said saturated polymer has an unsaturation content in the backbone of said saturated polymer of less than about 10 percent.

7. The elastomer composition in accordance with claim 1, wherein either said saturated or said unsaturated elastomer or both further comprises pendant groups randomly distributed along the elastomeric polymer backbone, wherein said pendant groups include an olefinic or vinyl double bond.

8. The elastomer composition in accordance with claim 1, wherein said saturated elastomer is a saturated organic elastomer.

9. The elastomer composition in accordance with claim 1, wherein said saturated elastomer is a saturated inorganic elastomer.

10. The elastomer composition in accordance with claim 1, wherein said saturated elastomer and said unsaturated elastomer form a thermoset elastomer composition.

11. The elastomer composition in accordance with claim 1, wherein said composition further comprises about 40 phr of said unsaturated elastomer.

12. An elastomer part, comprising a mixture of:
at least 50 parts per hundred rubber (phr) of a saturated elastomer;
less than 50 parts per hundred rubber of an unsaturated elastomer, wherein the elastomer part is halogenated after vulcanization producing the elastomer part having a reduced tack at least 60 percent lower than a saturated tack of a part having said saturated elastomer mixed with between about 40 phr and about 50 phr of said unsaturated elastomer, wherein said part is vulcanized but not post vulcanization halogenated.

13. The elastomer part in accordance with claim 12, wherein the elastomer part further comprises a halogen concentration gradient that decreases from an exterior surface of the elastomer part to an interior region of the elastomer part.

14. The elastomer part in accordance with claim 12, wherein the elastomer part further comprises:
an exterior surface; and
an interior region, wherein the halogen concentration at said interior region is less than the halogen concentration at said exterior surface.

15. The elastomer part in accordance with claim 12, wherein said at least 50 parts per hundred rubber of said saturated elastomer further comprises at least 75 phr of said saturated elastomer, and wherein the less than 50 parts per hundred rubber of said unsaturated elastomer further comprises less than 25 phr of said unsaturated elastomer.

16. The elastomer part in accordance with claim 12, wherein the less than 50 parts per hundred rubber of said unsaturated elastomer further comprises said unsaturated elastomer in the range from about 10 phr to about 20 phr.

17. The elastomer part in accordance with claim 12, wherein said saturated elastomer further comprises said saturated elastomer having a first solubility parameter, and wherein said unsaturated elastomer further comprises said unsaturated elastomer having a second solubility parameter, wherein the difference between said first and said second solubility parameters is at least 3.5.

18. The elastomer part in accordance with claim 12, wherein said saturated elastomer and said unsaturated elastomer form a thermoset elastomer part.

19. A fluidic device, comprising:
an elastomer part, comprising a mixture of:
at least 50 parts per hundred rubber (phr) of a saturated elastomer;
less than 50 parts per hundred rubber of an unsaturated elastomer, wherein the elastomer part is halogenated after vulcanization producing the elastomer part having a reduced tack at least 60 percent lower than a saturated tack of a part having said saturated elastomer mixed with between about 40 phr and about 50 phr of said unsaturated elastomer, wherein said part is vulcanized but not post vulcanization halogenated; and
a fluid reservoir coupled to said elastomer.

20. The fluidic device in accordance with claim 19, wherein said elastomer part further comprises a halogen concentration gradient that decreases from an exterior surface of said elastomer part to a central interior region of said elastomer part.

21. The fluidic device in accordance with claim 19, wherein said saturated elastomer further comprises said saturated elastomer having a first solubility parameter, and wherein said unsaturated elastomer further comprises said unsaturated elastomer having a second solubility parameter, wherein the difference between said first and said second solubility parameters is at least 3.5.

22. The fluidic device in accordance with claim 19, wherein said saturated elastomer and said unsaturated elastomer form a thermoset elastomer part.

23. The fluidic device in accordance with claim 19, wherein said at least 50 parts per hundred rubber of said saturated elastomer further comprises at least 75 phr of said saturated elastomer, and wherein the less than 50 parts per hundred rubber of said unsaturated elastomer further comprises less than 25 phr of said unsaturated elastomer.

24. The fluidic device in accordance with claim 19, further comprising a fluid routing structure having at least one fluidic pathway disposed therein, wherein said fluid reservoir is fluidically coupled to said at least one fluidic pathway, wherein said elastomer part is disposed between said fluid routing structure and said fluid reservoir.

25. A fluid ejection device, comprising
a fluid ejector;
a fluid routing structure; and
an elastomer gasket disposed between said fluid ejector and said fluid routing structure wherein said elastomer gasket includes a blend of at least 50 parts per hundred rubber (phr) of a saturated elastomer and less than 50 parts per hundred rubber of an unsaturated elastomer, wherein the elastomer gasket is halogenated after vulcanization.

26. The fluid ejection device in accordance with claim 25, wherein said elastomer gasket has a tack at least 60 percent lower than a saturated tack of a gasket having said saturated elastomer mixed with between about 40 phr and about 50 phr of said unsaturated elastomer, wherein said gasket is vulcanized but not post vulcanization halogenated.

27. The fluid ejection device in accordance with claim 25, wherein said saturated elastomer further comprises said saturated elastomer having a first solubility parameter, and wherein said unsaturated elastomer further comprises said unsaturated elastomer having a second solubility parameter, wherein the difference between said first and said second solubility parameters is at least 3.5

28. The fluid ejection device in accordance with claim 25, further comprising:
a fluid ejector substrate having said fluid ejector disposed thereon;
a substrate carrier having at least one fluidic pathway disposed therein, wherein said fluid ejector is fluidically coupled to said at least one fluidic pathway, wherein said elastomer gasket is disposed between said fluid routing structure and said substrate carrier.

29. The fluid ejection device in accordance with claim 25, wherein the elastomer gasket further comprises:
an exterior surface; and
an interior region, wherein the halogen concentration at said interior region is less than the halogen concentration at said exterior surface.

30. A method of making an elastomer part, comprising halogenating a vulcanized tacky elastomer part, said vulcanized tacky elastomer part having a vulcanized tack and having at least 50 parts per hundred rubber (phr) of a saturated elastomer and less than 50 parts per hundred rubber of an unsaturated elastomer to form a low tack elastomer part having a halogenated tack at least 20 percent lower than said vulcanized tack of said vulcanized tacky elastomer part.

31. The method in accordance with claim 30, wherein said halogenated tack is at least 50 percent lower than said vulcanized tack of said vulcanized tacky elastomer part

32. The method in accordance with claim 30, wherein said elastomer part further comprises a halogen concentration gradient that decreases from an exterior surface of said elastomer material to a central interior region of said elastomer material.

33. The method in accordance with claim 30, wherein said saturated elastomer further comprises said saturated elastomer having a first solubility parameter, and wherein said unsaturated elastomer further comprises said unsaturated elastomer having a second solubility parameter, wherein the difference between said first and said second solubility parameters is at least 3.5.

34. The method in accordance with claim 30, wherein said at least 50 parts per hundred rubber of said saturated elastomer further comprises at least 75 phr of said saturated elastomer, and wherein the less than 50 parts per hundred rubber of said unsaturated elastomer further comprises less than 25 phr of said unsaturated elastomer.

35. The method in accordance with claim 30, wherein said saturated elastomer and said unsaturated elastomer form a thermoset elastomer blend.
